(19) United States
(12) Patent Application Publication
(10) Pub. No.: US 2023/0249814 A1
(43) Pub. Date: Aug. 10, 2023

(54) System for Horizontal Take-off and Landing

(71) Applicant: Sunil Srivastava, Fremont, CA (US)

(72) Inventor: Sunil Srivastava, Fremont, CA (US)

(21) Appl. No.: 18/099,896

(22) Filed: Jan. 20, 2023

Related U.S. Application Data
(60) Provisional application No. 63/308,261, filed on Feb. 9, 2022.

(51) Int. Cl. B64C 29/00; B64C 23/06; B64C 19/02

(52) U.S. Cl. CPC B64C 29/0008; B64C 23/076; B64C 19/02

(57) ABSTRACT

A system for creating thrust for flying machines with Vertical Take Off and Landing (VTOL) including a first propulsion unit, a second propulsion unit, a top winget, a bottom winget, two or more tracks running over said first and second propulsion units, and wherein the two or more tracks are configured to mount said top and bottom wingets.

### CROSS-REFERENCE TO RELATED APPLICATIONS

The present Utility patent application claims priority benefit of the [U.S. provisional application for patent Ser. No. 63/308,261 entitled “Horizontal Take Off and Landing (HTOL) and Short Horizontal Take Off and Landing (SHTOL) Airplane-Energy Compatible with Vertical Take Off and Landing (VTOL) Helicopter-like Propulsion Engine and Pod Unit or Small Wings within Larger and Compound Wing Design with Crash Safe, Fault Tolerant, Load Sharing and Scaling and Low Noise Level Design Approach”, filed on 9 Feb. 2022, under 35 U.S.C. 119(e). The contents of this/these related patent application(s) is/are incorporated herein by reference for all purposes to the extent that such subject matter is not inconsistent herewith or limiting hereof.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to flying machines. More particularly, certain embodiments of the invention relate to flying machines with Vertical Take Off and Landing (VTOL) capabilities where the flying machines may hover, take off and land vertically without relying on a runway.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that typical Helicopters, Quadcopters, Aeroplanes, Cyclorotor and Fan Wings may hover, take off and land vertically but may not be energy efficient like airplanes. Lift depends on the choice of Airfoil shape, speed, area, and angle of attack. An airfoil is a structure with curved surfaces designed to give a favorable ratio of lift to drag in flight, and may be used as the basic form of the wings, fins, and horizontal stabilizer of most aircraft. An airfoil or aero foil is the cross-sectional shape of the structure whose motion through gas is capable of generating significant lift, such as a wing, a sail, or the blades of propeller, rotor, or turbine.

It is well-known for large passenger planes, flaps in rear of wings are used to increase lift as the plane lands or takes off at slower speeds. For lift, airplanes need runway to run and provide moving airflow over the wings to generate lift. VTOL does not rely on runways to provide lift.

Historically, there are a few ways to fly and take off. For Horizontal Takeoff and Landing (HTOL), Airplanes may be the best for energy efficiency and load carrying capacity equipped with some kind of a set of propulsion engines, like propellors, turbo props, turbo fan and turbo jets. For Vertical Takeoff and Landing (VTOL), Helicopters may be the best. With the advent of Radio-Controlled UAVs and Drones, the approach has been using propellors or rotating blades for both VTOL and HTOL, but they have challenges for loading, range, and duration for electric versions as well as hybrid versions. Flying cars and EVTOL machines are in the race with some hundred companies starting from Boeing, Airbus, and so on. Cyclocopter based Vectored Thrust for HTOL, and VTOL has been there, but they do not scale because of many issues beyond the topic and have not seen any commercial success. With the advent of technology and new materials and manufacturing process, Cyclocopter may have some niche application. For speed and load, they pose challenge as with 3 or 4 blade airfoils, which are found to be optimized around that number, the loading on each blade and associated bearings does not permit load sharing and scaling. Cyclocopters may have extra appendix addendum of offset hubs and linkages for pitch control which are difficult to scale to big size, speed, and loads. Cross Flow based Fan Wing are also in studies, but there has not been any commercial application and may have slow speed in spraying applications in Farming and Fire Fighting.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary ladder of tandem series of airfoils, in accordance with an embodiment of the present invention;

FIG. 2 is an illustration of an exemplary series of trailing flaps and leading slot used for increasing lift at slow speed, in accordance with an embodiment of the present invention;

FIG. 3 is an illustration of an exemplary Ladder of Rotating Tandem Series of Airfoils in VTOL Mode with Passive Load Bearing and Guidance, in accordance with an embodiment of the present invention;

FIG. 4a-FIG. 4c are illustrations of an exemplary side view of a Ladder of Rotating Tandem Series of Airfoils, in accordance with an embodiment of the present invention;

FIG. 5 is an illustration of an exemplary Flying Wing as Body Configuration, in accordance with an embodiment of the present invention;

FIG. 6 is a top view of an exemplary flying car configuration, in accordance with an embodiment of the present invention;

FIG. 7 is an illustration of an exemplary Load Bearing Track, in accordance with an embodiment of the present invention;

FIG. 8a-f are illustrations of various exemplary passive load bearing roller or gear bearing tracks, in accordance with an embodiment of the present invention;

FIG. 9 is an illustration of an exemplary active load traction motor belt arrangement with carrier mounts for airfoils, in accordance with an embodiment of the present invention;

FIG. 10a-e are illustrations of exemplary active load traction motor belt arrangements with carrier mounts for airfoils, in accordance with an embodiment of the present invention;

FIG. 11a-b are illustrations of exemplary active load traction motor belt arrangements with carrier mounts for airfoils using Linear Magnetic Induction Motor, in accordance with an embodiment of the present invention;

FIG. 12 is an illustration of an exemplary active load traction motor belt arrangement with carrier mounts for airfoils using Electrostatic Motor, in accordance with an embodiment of the present invention;

FIG. 13 is an illustration of an exemplary active load traction motor belt arrangement with carrier mounts for airfoils using embedded Aluminum Spikes in Linear Stator and Rotor to maximize charge transfer area, in accordance with an embodiment of the present invention;

FIG. 14 is an illustration of an exemplary pitch control track, in one approach, in accordance with an embodiment of the present invention;

FIG. 15 is an illustration of an exemplary pitch control track, in another approach, in accordance with an embodiment of the present invention;

FIG. 16a-b are illustrations of exemplary wheels with actuator foe, with and without linear actuators in wheel support, in accordance with an embodiment of the present invention;

FIG. 17a-b are illustrations of an exemplary shape shifting wing with slots and flaps, in accordance with an embodiment of the present invention;

FIG. 18 is an illustration of an exemplary shape shifting compound wing, with many sections of passive, load bearing and pitching interconnecting tracks like rail lines, in accordance with an embodiment of the present invention;

FIG. 19 is an illustration of an exemplary shape shifting compound wings of compound wings, with many sections of compounds wings for FIG. 18, in accordance with an embodiment of the present invention;

FIG. 20 is a side view of an exemplary rail track, in accordance with an embodiment of the present invention;

FIG. 21 is a cross section view of an exemplary rail and carriage, with passive mechanical or passive magnetic rail guide with bearings, in accordance with an embodiment of the present invention;

FIG. 22 is an illustration of an exemplary magnetic linear motor and/or rail-gun topology-based roller coaster, in accordance with an embodiment of the present invention;

FIG. 23 is an illustration of an exemplary motor driven rollers, like train wheels on tracks, in accordance with an embodiment of the present invention;

FIG. 24 is an illustration of an exemplary roller coaster with rail and electric mounted armature with EDFs co mounted, in accordance with an embodiment of the present invention;

FIG. 25 is an illustration of an exemplary magnetic belt gear drive mechanism, in accordance with an embodiment of the present invention;

FIG. 26 is an illustration of an exemplary roller coaster, in accordance with an embodiment of the present invention;

FIG. 27a-c are illustrations of exemplary rack and pinion-based traction and pitching tracks based on planetary gear, in accordance with an embodiment of the present invention. In one embodiment of the present invention, FIG. 27a shows a rack and pinion motor traction on rail, FIG. 27b shows a planetary gear-based rolling and pitching, and FIG. 27c shows a rack and pinion slider for pitch control around corners;

FIG. 28a-b are illustrations of an exemplary looping while keeping top-down carriage orientation up, in accordance with an embodiment of the present invention; and

FIG. 29 is an illustration of an exemplary looping in 3D with constant lift generation, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Wingets—a series of many small wings or airfoils.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit “about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said, “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred, or induced by any pattern(s) of description, embodiments, examples, or referenced prior-art that may (or may not) be provided in the present patent.

References to “end user”, or any similar term, as used herein, is generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. . . . sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention and variations thereof, relate to flying machines with Vertical Take Off and Landing (VTOL) capabilities where the flying machines may hover, take off and land vertically without relying on a runway. In one embodiment of the present invention, a series of Flaps in slanted diagonal formation, following an angle of attack profile for pitching, are used in Passenger Wings to increase lift at low speeds with landing and takeoff. Slats may be used for the same concept for high angle of attack for pitching which adds camber to an overall shape of the airfoil wing. The high velocity air below the Slat is made to pass over the main wing, and air below a leading Flap are passed over the next trailing Flap and so on. This approach makes the Airflow stick to the shape of the giant airfoil and not get disengaged from attaching to the surface because of High Angle of Attack, Boundary Layer Effects, and Rear Wake Up, where the High- and Low-Pressure Air Flows Wing, push back the Low-Pressure Point over the Wings, and reduce the Overall Lift.

The present invention will now be described in detail with reference to embodiments thereof as illustrated in the accompanying drawings.

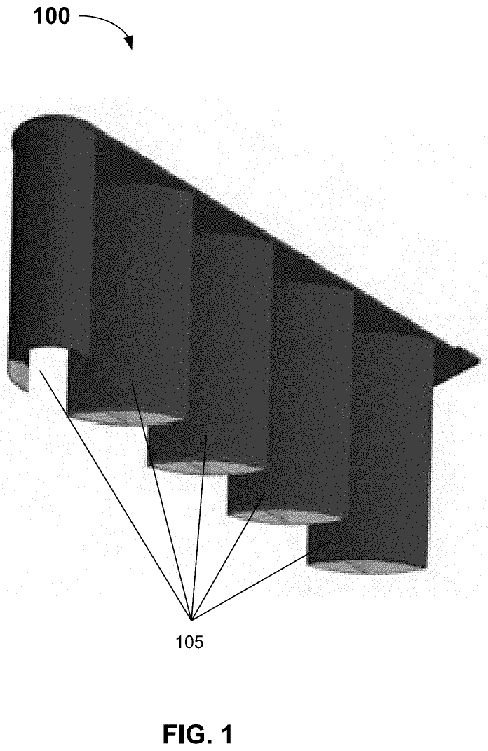

FIG. 1 is an illustration of an exemplary device 100 including a ladder of tandem series of two or more airfoils 105 or wingets, in accordance with an embodiment of the present invention. In one embodiment of the present invention, device 100 may include a series of one or many small Wings or airfoils 105, called Wingets, that are rotated in a close loop without moving a vehicle on a runway, to create thrust both for VTOL and HTOL.

In some embodiment, device 100 may comprise a ladder like tandem series of airfoils 105 that are moved at runway speeds but in a close loop like an escalator such as the ones found in Office Buildings, Business Parks, Malls, Railway or Metro Stations, and Airports.

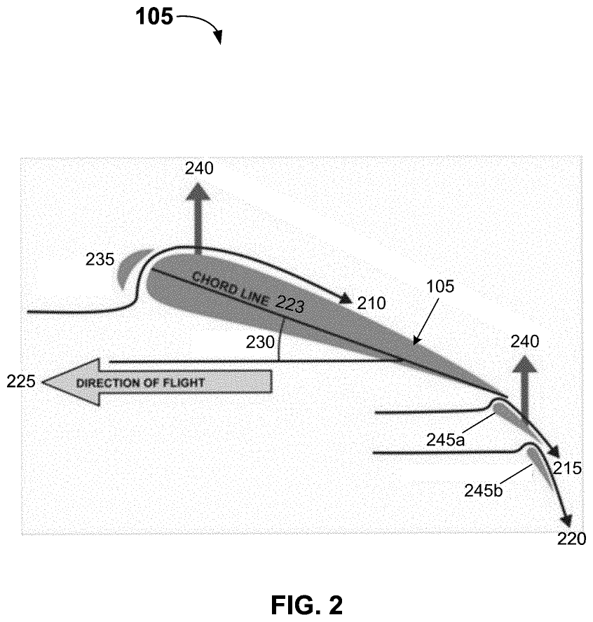

FIG. 2 is an illustration of an exemplary airfoil 105 including a series of trailing flaps 245a, 245b and leading slat 235 used for increasing lift 240 at slow speed, in accordance with an embodiment of the present invention. Airflow 210 through leading slat 235 and airflows 215 220 through airfoil 105 with a direction of flight 225 and a predetermined angle of attack 230 with respect to chord line 223 is shown. In one embodiment of the present invention, an additional lift (e.g., coefficient of lift may be 5 or more) may be provided caused by COANDA effect 240 in predetermined angle of attack 230 and direction of flight 225, with the use of extended slat 235 and extended flaps 245. Takeoff flap settings may vary between five (5) to fifteen (15) or seventeen (17) degrees. An aircraft may use the takeoff flap settings with leading edge slats 235. For landing, an aircraft may use twenty-five (25) to forty (40) degrees of flap setting.

In some embodiment, the device may be extending or flattening a Cyclocopter in one virtual sense, like a series of cascaded Cyclorotors with shared boundaries between adjacent Cyclotoros, except trailing and leading edges physically cancelling the air flow motions. In Cyclorotors only about 2 out of 4 Blades, or about 1.5 out of 3 Blades, that is approximately 50% of blades providing VTOL or HTOL Thrust but in the invention, it has n/m times improvement in efficiencies compared to the Cyclorotors, where “n/m” is the aspect ratio of the ladder profile, e.g., length of the ladder by width. A Cyclorotor may not have any higher number of blades than four (4) as they do not optimally scale for energy and thrust. In some embodiment, the airfoils are split into two or more many halves and joining them with two or more tracks like tractor on wheels. The airfoils are pitch controlled through pitch control linkages. The Power Traction Track provides the power for traction like a Third (and Fourth) Power rail providing electric power, the Passive Bearing Traction provides the bearing and guidance like two Rail Tracks, and the Pitching Track providing Pitching Angle Support by Offset Mechanism. The Pitching Track may be relatively adjusted into center offset positions, compared to the rest of the Tracks. In such a manner, in Up, Neutral, and Bottom directions, such that only Wingets in Bottom are Pitched, Wingets in both Bottom and Top are Pitched, or Wingets in Top are pitched. When Pitch track goes up, the bottom Wingets get pitched. The wingets going down and up on the sides or width of the ladder, do not get pitched and they remain neutral but most of the Blade Airfoil remain in a predetermined pitch angle between five (5) to seventeen (17) degrees for takeoff and twenty-five (25) to forty (40) degrees for landing based on available flaps data for a duration of the horizontal track joining the two half circles and not oscillate to-and-fro at very fast frequency.

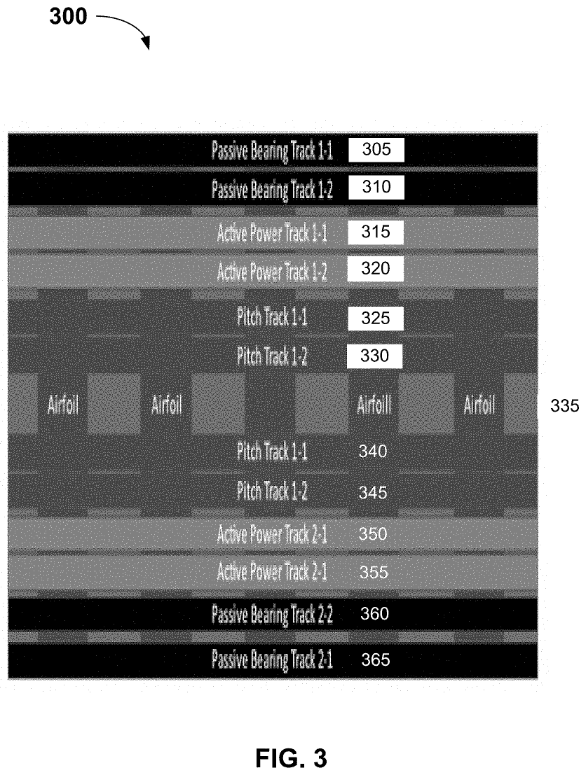

FIG. 3 is an illustration of an exemplary thrust, load and pitching bearing track, guidance bearing track and pitching track—compound track 300, in accordance with an embodiment of the present invention. In one embodiment, compound VTOL and HTOL Thrust bearing track 300 may include passive guidance bearing track 305 310 360 365, active power track 315 320 350 355, pitch track 325 330 350 355 and may rotate a tandem series of airfoils 335 in VTOL and HTOL modes with passive load bearing for track guidance with traction track providing power and pitching track providing adjustments for pitching angles with offset mechanisms, like the offset hub of a cyclo rotor (think of the round hub becoming a rectangle). The load bearing and guidance rail track may provide rigidity and vibration damping. The load bearing and guidance rail track may include at least two (2) or more load bearing and guidance rail tracks like rails for load balancing and fault tolerance. The thrust, load and pitching bearing track, guidance bearing track and pitching track—compound track —300 will further include Active Power Traction through options of combinations of Mechanical Belt and Pulleys, Local Servo Driven Wheels, Local Mounted EDF Jets, Rack and Pinion Gears, Magnetic Gears, Linear Magnetic Motor, Linear Induction Motor, Electrostatic Motor, etc. with 315 320 350 355 for moving Airfoil Blade 335, two (2) or four (4) Tractions for Load Balancing and Fault Tolerance as well. Similarly, Pitching Control Guiding Rail Tracks 325 330 340 345 for Load Balancing and Fault Tolerance as well. A “Clustering” approach is taken to reduce loading on Blade Airfoils, Bearings, etc.

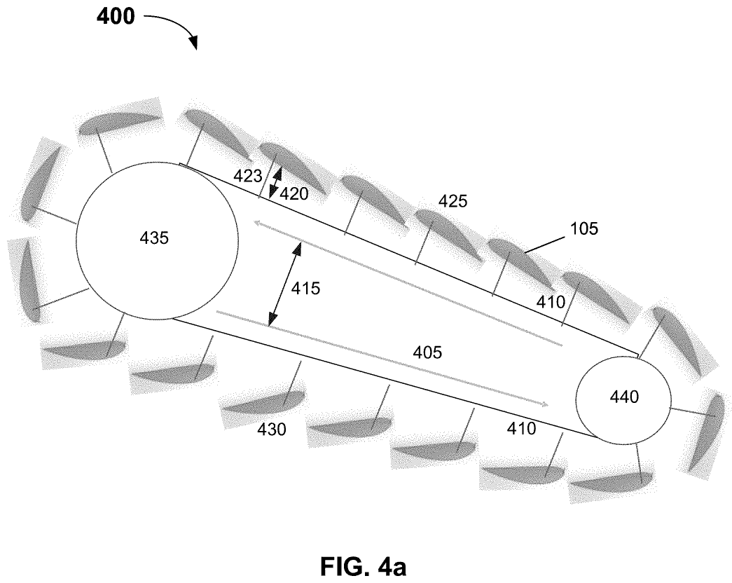

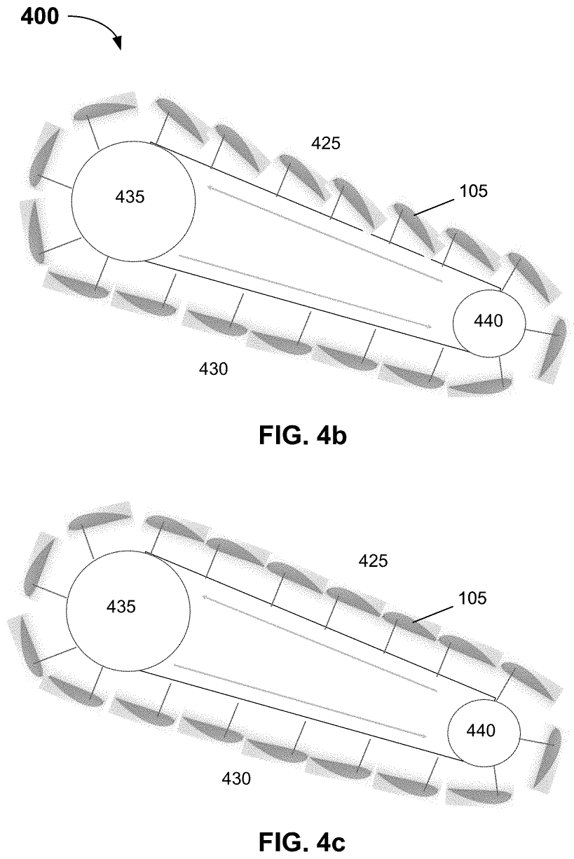

FIGS. 4a-c are illustrations of an exemplary ladder of rotating tandem series of airfoils or wingets 400, in accordance with an embodiment of the present invention. In one embodiment, angle of attack of top airfoils or wingets 425 and bottom airfoils or wingets 430 moves and creates lift for VTOL and reverse or forward thrust for HTOL in four combinations of modes. In a VTOL mode, both Top 425 and Bottom 430 Airfoils or wingets may generate VTOL Additive Lift while the Thrust for HTOL may be cancelled. In a Forward HTOL mode as shown in FIG. 4a, bottom Airfoils or wingets 430 are pitched and may push the air flow behind while top wingets 425 are not pitched. In the Backward HTOL mode as shown in FIG. 4b, Top Airfoils 425 are pitched and may push the air flow to the front while bottom wingets 430 are not pitched. In one simple Belt and Pulley Mechanism, Mechanical or with Magnetic Gear, they are wheels giving guidance for that part of the Active, Passive and Pitching Tractions that may provide a neutral pitching for that part of the sections, unlike top and bottom sections of the pitching tracks. FIG. 4c shows no VTOL or HTOL configuration where both top 425 and bottom 430 wingets are not pitched.

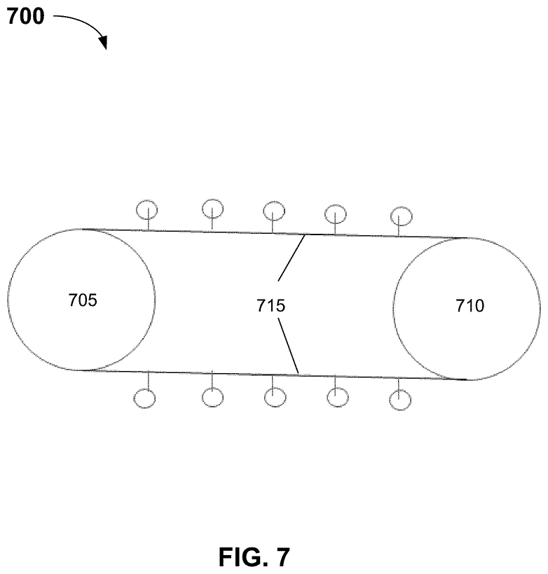

There are at least four (4) configurations for coarse granularity. First, both Top 425 and Bottom 430 airfoils or wingets are Pitched for VTOL (e.g., Forward and Reverse HTOL Thrusts cancel out). Second, top airfoils 425 are Pitched for VTOL and HTOL Reverse Thrust. Third, bottom airfoils 430 Pitched for VTOL and HTOL Forward Thrust. And Fourth, no Pitching for VTOL or HTOL Thrust. Two (2) to four (4) tracks 410 like ring gear may provide rigidity and failsafe with the purpose of passive bearing and traction. For example, two (2) to four (4) tracks will run over motor driven pulley through drive belts, in one simple implementation (while there are many different approaches mentioned later using combinations of Mechanical, Magnetic, Electric, and Electrostatic Propulsion systems) 435 440 The Propulsion Power Source is the Electric Motor and the Propulsive System is the invention itself where the Power Traction to Pull Airfoils is through the Active Power Track or Active Track—besides the Passive Track providing Bearing and Guidance to Axles to hold Airfoils and Pitch Track to Pitch the Airfoils through Offsetting Mechanism of the Pitch Track to pull axles. The Axle is the rod axle like of a car connecting two bearings on two Passive Tracks and are the center of smaller circles in FIG. 7 connecting to similar corresponding smaller circle of another track which is also Passive Track with mounted airfoils 105 (e.g., top winget 425 and bottom winget 430). The Link 423 is connecting the bearing on the Passive Track to the Bearing at Center of Gravity of the Airfoil 105. Wing angle of attack 405 in forward HTOL motion may provide lift. Active Power Traction may be implemented through options of combinations of Mechanical Belt and Pulleys, Local Servo Driven Wheels, Local Mounted EDF Jets, Rack and Pinion Gears, Magnetic Gears, Linear Magnetic Motor, Linear Induction Motor, Electrostatic Motor, etc. Pitch traction offset controlled micro frame 423 may be controlled with actuator sliding bars 420. Pitch traction offset 415 may be controlled as meta frame. Meta Frame is a Pitching Track Frame, which provides main first pitching controls in the four (4) different configuration modes, Geometrically Congruent, to Active Power Traction and Pass Load Bearing Track Geometry which is two semicircles of the diameter of the shorter sides of a rectangle and on the shorter sides of a rectangle. A Pitching Guidance Traction Rail mechanism.

The Pitching Track is of the same geometry as the Active Power Track and Passive Bearing Track while the last two Tracks have the same Center of Geometry, the Pitching Center can be aligned or offsetted with variation for various Pitching Angles and the similar concept is there in Cyclo Rotors may provide four (4) different Pitching Configurations, namely: (1) Both Top and Bottom Sides (e.g., top winget 425 and bottom winget 430) Pitched for VTOL only. (2) Top Side 425 Pitched and Bottom Side 430 Retreated for VTOL and Reverse Thrust, and (4) Bottom Side Pitched and Top Side Retreated for VTOL and Forward Thrust and (4) Both Sides 425 430 Retreated. When wingets 105 are pitched up, they create lift like a regular wing in a plane, and the many series of tandem airfoils or wingets may provide lift like many tandem wings in a plane or many planes tied together into a meta-frame. When the pitched top wingets are tracked moved forward, like wings, they also push air flows forward, thus creating a reverse HTOL Thrust by Newtons Third Law. The reverse is true for Retreating Pitched Bottom Wingets which move backwards while pitching. When the Pitching Frame is moved in steps in vertical direction, an offset geometry may be created where the center of Pitching Frame is not aligned with the centers of Active and Passive Track Frames, which may result in the Wingets being pitched up in four different modes mentioned above. Minor adjustments may be done through a micro actuator frame within a Meta Pitching Actuator Frame.

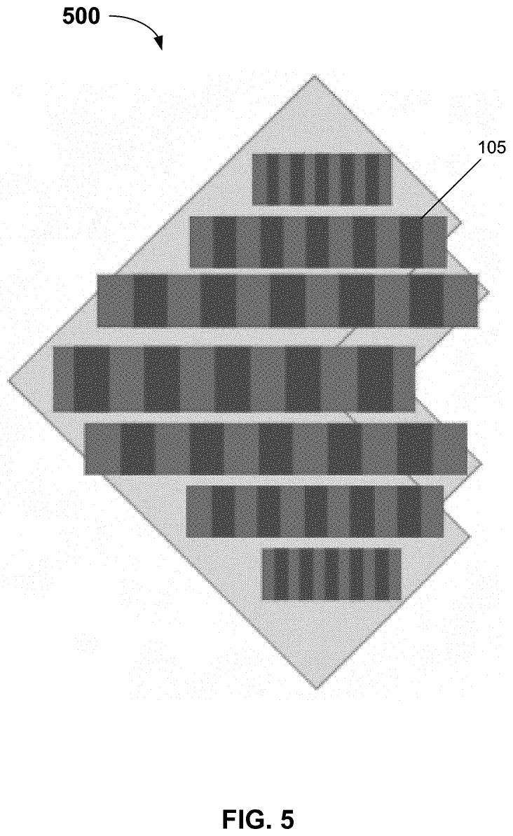

FIG. 5 is an illustration of an exemplary flying wing as body configuration, in accordance with an embodiment of the present invention. In one embodiment of the present invention, Flying Wing Configuration 500 is shown where many units of Wingets 105 are used as PODs. PODs are units of Thrust Engines. The Invention is itself a Propulsive System for VTOL and HTOL and Electric Motors provide the Force that may provide VTOL and HTOL Thrust in Combinations for HTOL and VTOL.

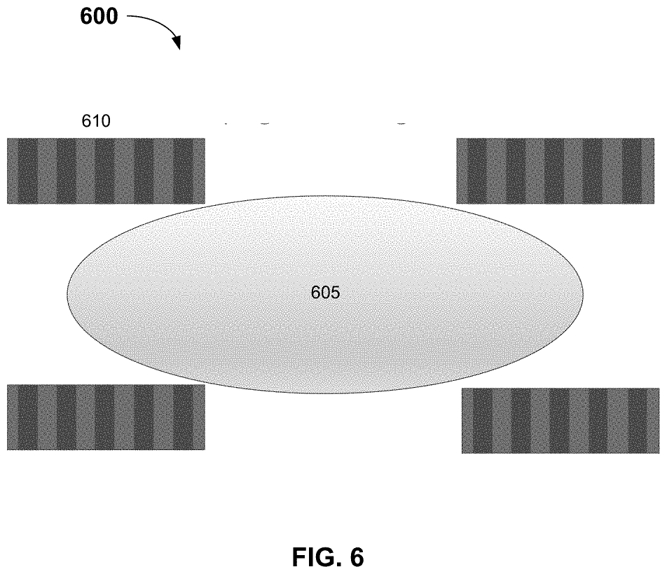

FIG. 6 is a top view of an exemplary flying car configuration, in accordance with an embodiment of the present invention. In one embodiment of the present invention, a Fail Safer/Fault Tolerant Flying Car or Bike 600 is shown and how the Compound Wing/POD 500 may be used for a Fail Safe and Crash Proof Flying Vehicle 600. Fail Safe and Crash Proof flying vehicle 600 may provide a Wing with Narrow and Fused Body with Array of PODs on the two Wings and may provide Flying Bike 600 with Body 605 and Flying PODs 610.

FIG. 7 is an illustration of an exemplary load bearing track, in accordance with an embodiment of the present invention. In one embodiment of the present embodiment, the load bearing track 700 is a passive load bearing track and may include frame rails 705 710 and dual belt 715 based traction for fail safety.

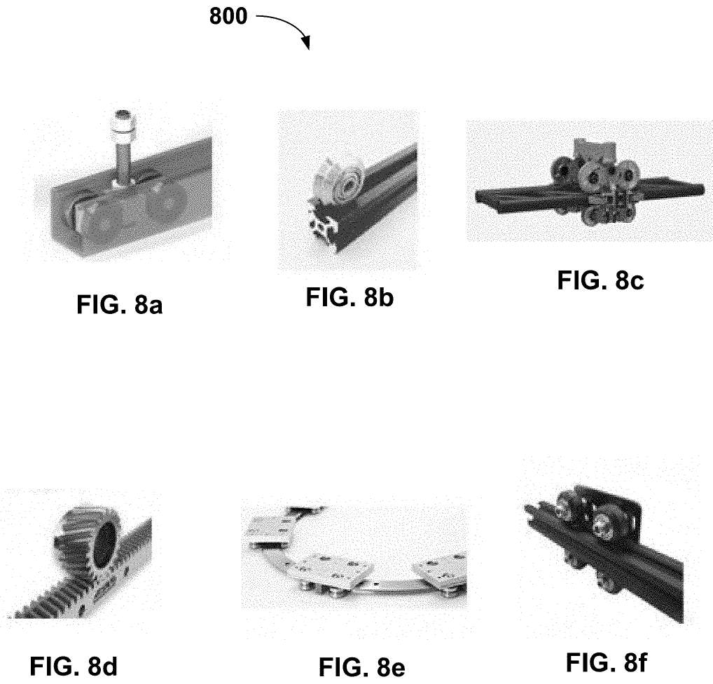

FIG. 8a-f are illustrations of various exemplary passive load bearing roller or gear bearing tracks 800, in accordance with an embodiment of the present invention. In one embodiment of the present invention, passive load bearing roller or gear bearing tracks 800 may provide various options for Power Traction mechanisms.

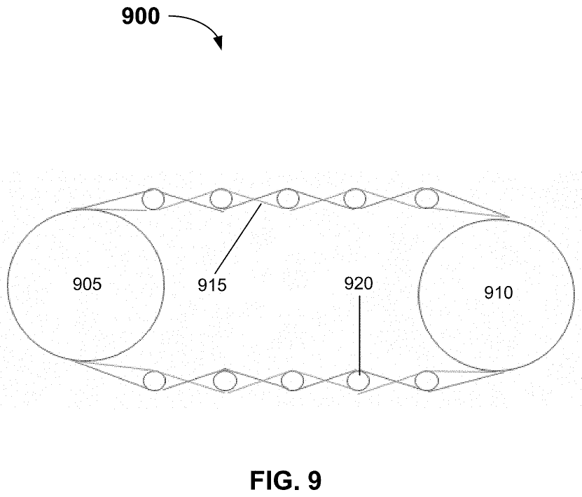

FIG. 9 is an illustration of an exemplary active load traction motor belt arrangement 900 with carrier mounts for airfoils, in accordance with an embodiment of the present invention. In one embodiment of the present invention, arrangement 900 may include, but not limited to, Active Power Traction Belts 915 920 for Load Balancing and Fault Tolerance. Arrangement 900 may include Driving Belt 915 and carrier attachment hooks to mount which may reduce the limit for high-speed belt operations. By having many foils and big area per foil, the need for speed may be reduced. In additional embodiments, arrangement 900 traction instead of Belt and Pulley, with mounting brackets for Wingets, may be substituted, with Linear Induction Motors with an array of 3-Phase Coils, which may add mass, and a sliding Aluminum Carrier that may provide Speed and Torque Control. In alternative embodiment, arrangement 900 may include Electrostatic Induction Motor which may reduce the mass but don't scale well for High Torque and High Speed, which may be increased if area of ion exchange is increased by having a 3D Array of Spikes made of Aluminum. The substratum holding spikes may be layered with high value Dielectric material such as but not limited to Teflon to increase the capacitance and charge holding density. In another variation, they the Belt and Pully Traction may have Magnetic Linear Gear Mounts, with Magnets mounted between two concentric pulleys like a sandwich and the Wingets with magnets attached to the belt.

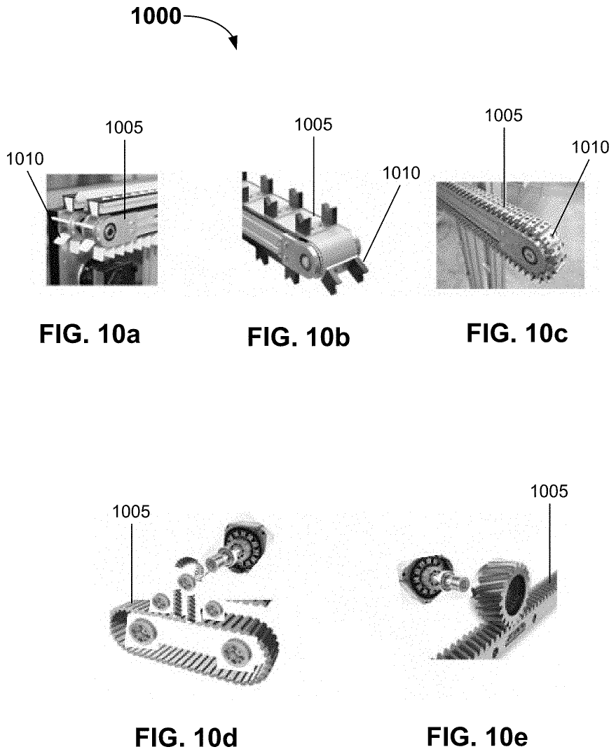

FIG. 10a-e are illustrations of exemplary active load traction motor belt arrangements 1000 with carrier mounts for airfoils, in accordance with an embodiment of the present invention. FIGS. 10a to 10c may provide track linear rolling chain 1005 like the ones used in tanks, or belt 1005 with screwed and attached mounting points 1010 where the Wingets may be mounted. FIG. 10d is a mechanism of rolling chains over two passive pulleys, but local wingets are driven through a locally mounted motor with three (3) local small pulleys, not two big ones shared by all wingets, which guide the pulleys to be driven by the geared pulley mounted on local co-located motor on the winget. FIG. 10e provide the Rack and Pinion Mechanism with locally mounted Motors. The track is geared and the Motors with mounted gears on each winget move over the tracks.

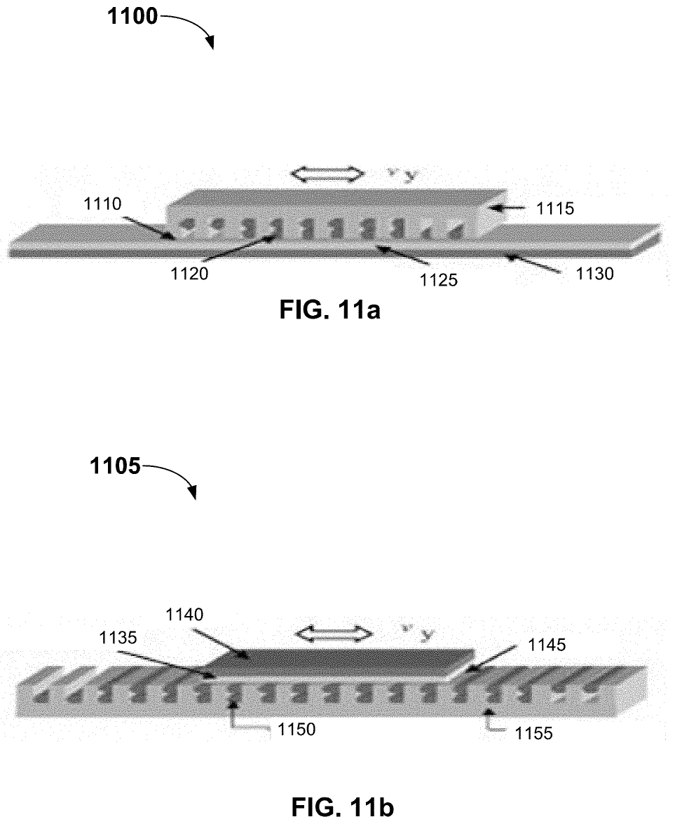

FIG. 11a-b are illustrations of exemplary active load traction motor belt arrangements with carrier mounts for airfoils, in accordance with an embodiment of the present invention. Referring to FIG. 11a, in one embodiment of the present invention, arrangement 1100, may include an air gap 1110, a primary core 1115, a three-phase primary winding 1120, a secondary sheet 1125, and a back iron 1130. Primary core 1115 may include a Rail Carriage on which Wingets are mounted. Three-phase primary winding 1120 may include Electro Magnetic Coils. Secondary sheet 1125 may include Aluminum Rail on which Rail Carriages Float. Back iron 1130 may include a Rail Bed on which Aluminum Rails are mechanically secured. Referring to FIG. 11b, in an alternative embodiment of the present invention, arrangement 1105 may comprise a mirror image of arrangement 1110 flipped upside down and may include a secondary sheet 1135, a back iron 1140, three phase primary winding 1150, air gap 1145, and primary core 1155.

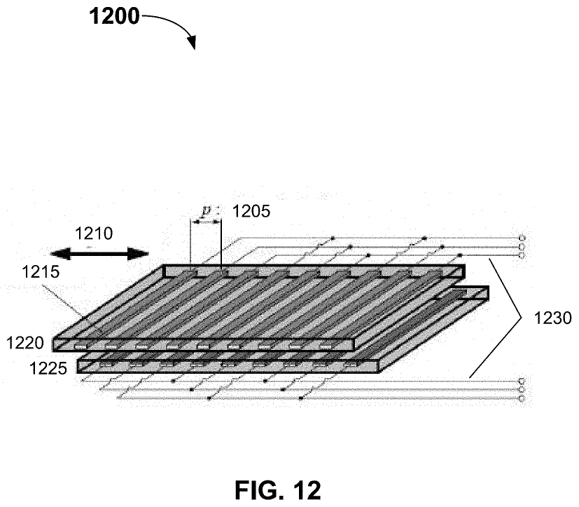

FIG. 12 is an illustration of an exemplary active load traction motor belt arrangement 1200 with carrier mounts for airfoils, in accordance with an embodiment of the present invention. Arrangement 1200 may comprise an Electrostatic Linear Motor or linear electrostatic induction motor for low mass and may include a plurality of electrodes 1215, a slider 1220, and a stator 1225. Driving direction 1210 may be bi-directional which may impart a bi-directional electrode pitch 1205. Cabling 1230 may connect the electrodes of the slider and stator to external circuitry. Electrodes 1215 are placed in bi-directional electrode pitch 1205, 1210 is the bidirectional motion of the rail carriage, 1220 is the Rail, 1225 is the Track and 1230 is the 3 Phased AC Circuit providing Charges to the Electrodes with Phase difference like Induction 1225 is Stattor and 1220 is Rotor, 1230 are 3 Phase Supply, 1205 are the pitched electrodes on Both Stator and Rotor.

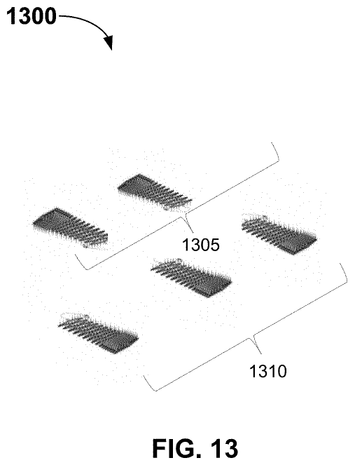

FIG. 13 is an illustration of an exemplary active load traction motor belt arrangement 1300 with carrier mounts for airfoils, in accordance with an embodiment of the present invention using Linear Electrostatic Induction Motor. Arrangement 1300 shows a linear electrostatic motor with spikes of aluminum including arrays of rotor spikes 1305, to increase the total surface area of electrostatic interaction, where airfoils are mounted and a three phase AC voltage feeding arrays of stator spikes 1310. Linear/Rotating Induction Motor, with use of N Phase, 2 to N Phases, AC Signals fed to Stator results in a Linear/Rotating Magnetic-field Motive Force, N-Phase AC Signals to Sharp Electrodes in Stator will lead to a Linear/Rotating Electric Fields. Magnetic or Electric Fields induced in Stator will in turn induce Magnetic or Electric Fields in the Rotor causing attractive and repulsive forces causing Linear/Rotor Motion.

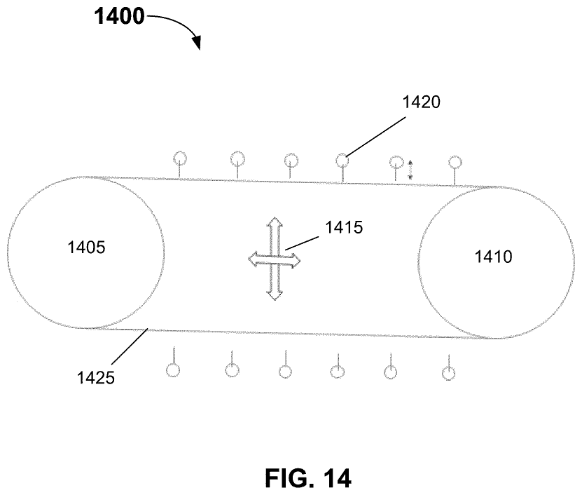

FIG. 14 is an illustration of a first exemplary pitch control track 1400, in accordance with an embodiment of the present invention. In one embodiment of the present invention, track 1400 may comprise a dual belt-based traction (it is dual Pitching Track and not dual belt Traction Belt) for fail safety and pitching and include two circles 1405 1410 (e.g., pitching frame rails to form Pitching tracks) that provides two levels of controls for giving at least four (4) combinations of Pitching Configurations, airfoils 1420, and Passive track 1425. Wheels are part of the Pitching tracks with two levels of controls with Actuators. A first set of vertical actuators may move track 1400 upside-downside and the second set of horizontal actuators, placed on top and bottom pitching rails, may move the track upside-downside, or clockwise/anti-clockwise pitch individual foils by creating drag on top or bottom portion of the winget foils in a linear-ring-planetary-linear-sun gear mechanism, for next two or more levels of combinations to give rise to at least total of four combinations of Pitching, which are: (1) Both Sides (e.g. top 425 and bottom 430 airfoils) Pitched for VTOL, (2) Both Sides 425 430 Retreated (see FIG. 4c), (3) Top Side Pitched and Bottom Side Retreated (see FIG. 4b), and (4) Bottom Side Pitched and Top Side Retreated (see FIG. 4a). For this Pitch Control, two sets of Vertical Linear actuators may be mounted on each half of the sections, one for upside and one for downside to give four configurations and saves the trouble of having moving actuators and assuming the airfoils will naturally be zero pitched when going over the wheels. The second level approach of clockwise/anti-clockwise pitch individual foils by creating drag on top or bottom portion of the winget foils in a linear-ring-planetary-linear-sun gear mechanism, is having horizontal tracks only for Upside-Downside Pitching without wheel tracks for Pitching sliders. The drag induced on top or bottom of Foils, either through Linear Ring or Linear Sun Gears, Linear Rails with EM Coils Attract Iron or Magnet Bars on Airfoils to create Drag, to create a torque/force against the Forward Force of the Motion caused by Traction, causing Clockwise or Counter-clockwise Pitching of the Foils. The Linear Tacks have Magnetic Coils as Linear Actuators and the Wingets Pitching Mounts in Top and Bottom of Wingets have Iron or Magnets attached to create a Drag in Top of Bottom of Wingets. The Airfoils have Linear Ring Gears in Top and Bottom that are driven by Bars with Magnets or Iron. The Linear Pitching Tracks with EM Coils are co-moving frames with the Pitching Track, Passive Load Bearing Track, Active Power Track—but may be at relative offsets with their centers. For First Pitch Control, two sets of Vertical Linear actuators may be mounted on each half of the sections, one for upside and one for downside to give four configurations and saves the trouble of having moving actuators and assuming the airfoils will naturally be zero pitched when going over the wheels. The Third Degree of Pitching Control, the Pitching Track Frame may be Rotated to from the plane of the HTOL Flight, to create Pitching Profiles. The Wheels Tracks will have Linear Actuators that will move in opposite directions to create this inclined plane with regards to HTOL plane. The airfoils may be zero pitched by default when going over the wheels.

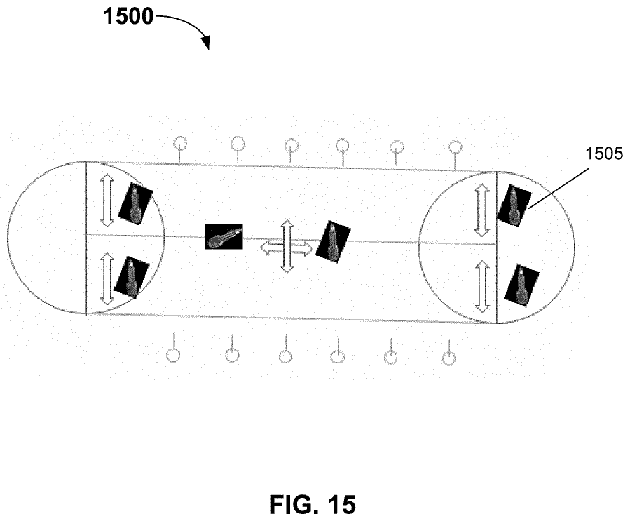

FIG. 15 is an illustration of a second exemplary pitch control track 1500, in accordance with an embodiment of the present invention. In one embodiment of the present invention, wheels may not be part of the tracks and with two independent levels of controls with Actuators for Vertical Movements.

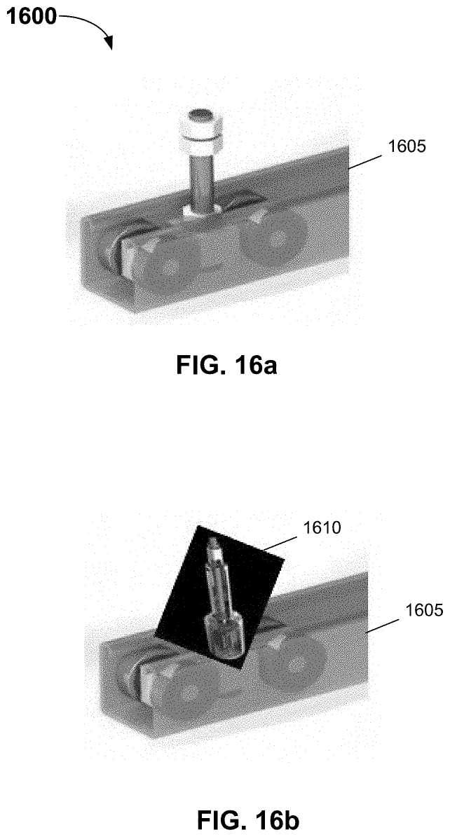

FIG. 16a-b are illustrations of exemplary wheels with alternative actuator configuration for Pitching Control, in accordance with an embodiment of the present invention. Referring to FIG. 16a, track carrier 1605 has no actuator. Referring to FIG. 16b, track carrier 1605 may include a pickup coil feeding actuator 1610. The wheels are on Pitching/Passive Load/Active Power Tracks driving the Airfoil Wingets, and they are suspended like wheels in cars over Shock Absorbers but here they are actually Linear Actuators which can move up and down.

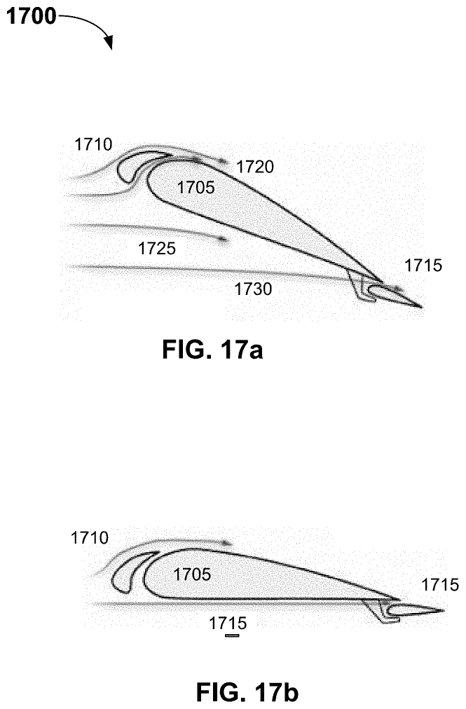

FIG. 17a-b are illustrations of exemplary shape shifting wings 1705 with slats 1710 and flaps 1715, in accordance with an embodiment of the present invention. The use of flaps 1715 may introduce too much drag that need to be managed. For Lift and Cruise there are different profiles needed. Referring to FIG. 17a-b, for VTOL, flaps 1715 may be stretched and for cruise, flaps 1715 may be retracted. Airflows 1720 1725 1730 are shown where FIG. 17a illustrates a ‘climb’ feature and FIG. 17b illustrates a ‘cruise’ feature. The Active Traction Belt Wheels may be laid in a topology that forms a Wing Profile as shown. The Traction Pulleys may be Passively or Actively delivering Torque through multiple Motors mounted at various Belt Wheels. The wheels be adjusted by actuators to alter the overall Profile of the Compound Wing. With Belt Driven System, the overall Belt Length may be made of the same perimeter with Moving Traction Wheels. The Passive Traction Wheel Rollers and Tracks may be split and divided to take the role of Passive Load Bearing and Guidance over a series of parts of a flexible topology of Track. The carrier may have more wheels to take turns over series of many tracks or have a broader wheel-base. The rollers and tracks may be moved closer to each other or stretched away from each other. Alternatively, the Carriers carrying the Airfoil Wings or Wingets, may be self-propelled with Small Magnetic Motors and power and control signals may be delivered wirelessly by the closest point on the track.

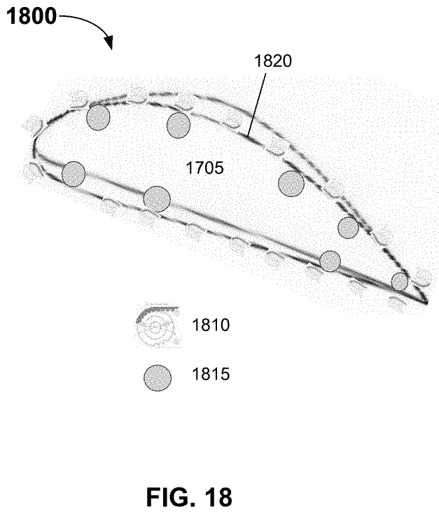

FIG. 18 is an illustration of an exemplary shape shifting compound wing configuration 1800, in accordance with an embodiment of the present invention. In one embodiment of the present invention, configuration 1800 may include airfoil 1705, belt geared carriers 1810 for carrying airfoil blades, driven by active/passive pulleys 1820, and passive traction guide rollovers 1815 for active traction. In some embodiment, multiple pulley-based traction track may shape wing airfoil profile. Multiple passive tracks in series may take over the burden of guidance of part of traction from one to the next. Tracks may be moved in coordination to alter airfoil profiles. Motor driven pulleys may be disposed at key points.

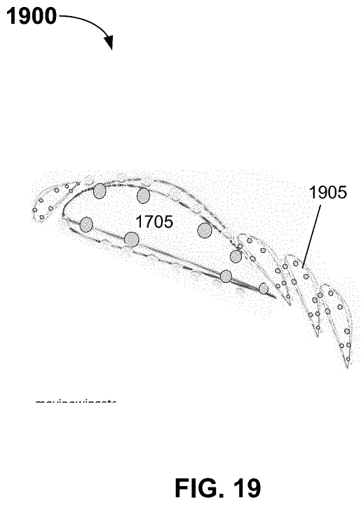

FIG. 19 is an illustration of an exemplary shape shifting compound wing 1900, in accordance with an embodiment of the present invention. Compound wing 1900 may include exemplary shape shifting wings 1705 scaled to become a Series of Optional Slats in a Leading Edge of Virtual Shaped Wing in the contraption of the Invention, and Trailing Optional Series of Optional Flaps of Virtual Shaped Wing 1905.

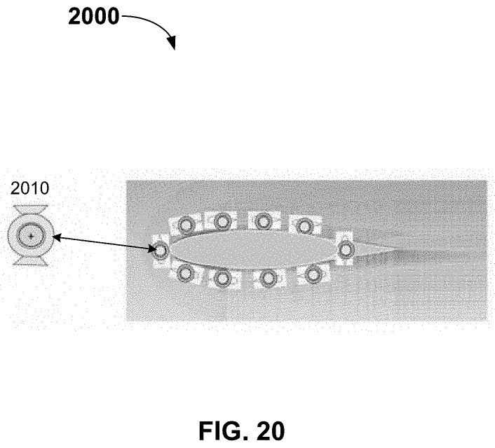

FIG. 20 illustrates a side view of an exemplary rail track 2000, in accordance with an embodiment of the present invention. In one embodiment of the present invention, the topology of the invention lends merit to integrating Linear Magnetic Induction Motor, Linear Electrostatic Motor and Lorentz Fore Linear Motor, aka Rail Gun-like, and integrate the Active and Passive Tracks. The pulley-based carriage system may limit the velocity of the Airfoil Blades. Both motors may be combined to have a hybrid. The Lorenz Force approach is called Railgun and instead of projectiles, Aluminum carriages may act as Armature with very high current to scale and limited as it would also create heating issues. The Linear Motor Magnetic Induction approach complements Lorentz Force, but the orientation of Coils may need to match the net Magnetic Field of the two Rails. This approach mandates use of AC. For DC approach, triggers may switch on and off the tracks like the BDLC Controller used in Magnetic Papers. The Linear Induction Motor may be based both on Reluctance from Iron, Eddy Current Induced Magnetic Field in Squirrel Cage like Linear Motor, Aluminum and Permanent Magnet, further needing a mixing optimization. An optimized design may create a lot of velocity and force, resulting in Thrust and Lift per Airfoil or Blade, called Wingets, and may help the Compound Wing. Linear Electrostatic Motor may pose similar options.

In some embodiment, rail track 2000 may include a plurality of carriages 2010. Asymmetrical Airfoils such as the Selig S1223 and FX 74-CL5 have shown Coefficient of Lift of up to approximately 2 to 2.5. This may mandate that the airfoil remain its “top” and “bottom” profiles as it goes around the loop tracks where things get inverted. The tracks around corners not only curve around by proximately 180 degrees, nearly but also twist the track in such a fashion, that the carriers Wingets maintain the top and bottom of their profiles. The other solution is tied with the Pitching Mechanism, where around the corners of bends, the carriages are flipped to maintain their orientation, and also used to get the desired pithing before entering top and bottom sections. In such a case, the carriages may be driven by the motors and the servo is responsible for flipping and pitching. The other solution is the Airfoils in Pitching Tracks may be shunted like Railway Tracks. The Top Track remains Top and Bottom Track remains Bottom, while going from Top to Down. Which means the two Top and Bottom Tracks may have to cross each other and timed well like two trains crossing a common shared section. The workaround will be the Top and Bottom Tracks are only supporting respecting Top and Bottom Bearings of the Wingets Airfoils, and in Vertical Plane, they are in two different planes with a shared Horizontal Planes, like a Straddle by a Horse Rider across two horses.

In additional embodiments, the Rack and Pinion Tracks are used along with the concept of Planetary Gears. Rack and Pinion is for Active Traction, and the other one is for Flipping and pitching. The Ring and Sun Gear are being driven by Motor and Servos and Planetary Gears are moving the Wingets. Here, the Sun and Ring Gears have become “Flattened and Straight”. The Pitching and Flipping Track may be just around the corners in Pairs for Fail Safe Operations.

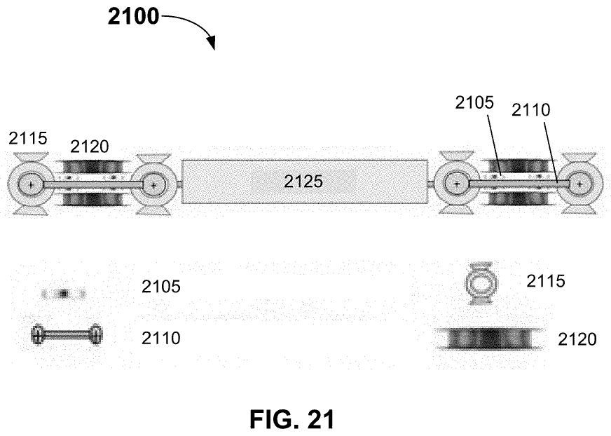

FIG. 21 is a cross section view of an exemplary rail and carriage 2100, in accordance with an embodiment of the present invention. In one embodiment of the present invention, rail, and carriage 2100 may comprise an integrated passive-active tracks with Lorentz motor and Linear Magnetic Induction motor with rail and armature carriage. Rail and carriage 2100 may include a light and Linear Rotor mounted Strong Magnets 2105 on Carriage 2100 such as but not limited to ALCO, an aluminum or iron carriage armature 2110, linear and curved rail aluminum sections 2115, electro-magnetic coil including Linear Induction Motor Stator 2120, and a comoving airfoil/blade mounted (not shown) on carriages 2125.

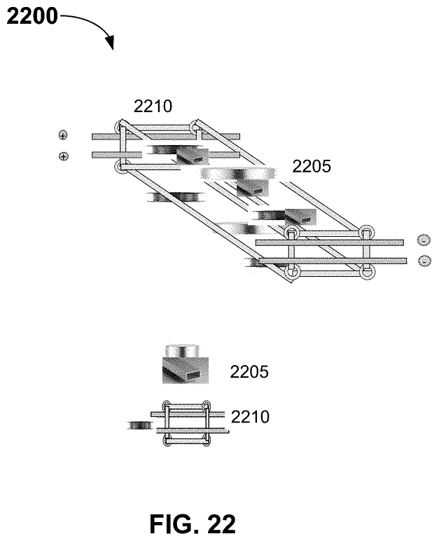

FIG. 22 is an illustration of an exemplary magnetic linear motor and rail-gun topology-based roller coaster 2200, in accordance with an embodiment of the present invention. roller coaster 2200 may include graphite, carbon fiber, iron, copper or aluminum, or combination of alloys made of listed elements, armature carriage with permanent magnets 2205 and graphite, carbon fiber iron, copper, or aluminum linear and curved rail with roller coaster guide 2210.

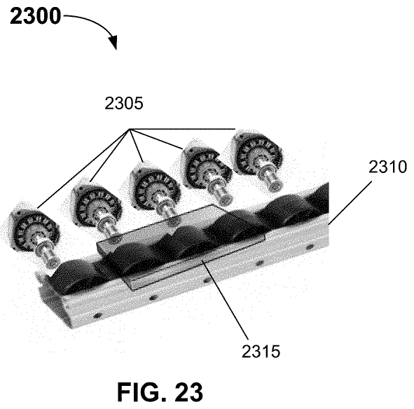

FIG. 23 is an illustration of an exemplary roller coasters spun by BDLC Rotational Motors and aluminum carriage rolling 2300 where traction is driven through the motors, in accordance with an embodiment of the present invention. Traction 2300 may include motors 2305 including but not limited to BDLC motors, motor driven rollers 2310, and a rolling slider 2315. Rolling slider 2315 may comprise but not limited to Urethane, Plastic, Carbon, Aluminum or Steel rolling slider. In alternative embodiment, rolling slider 2315 may comprise but not limited to aluminum or copper rollers, and open to other combination of alloys of copper, aluminum, iron, etc., which are rotated with high RPM BDLC Motor, and Linear/Roller Magnetic Gear based Sliders. With this approach, the bearings may have less load.

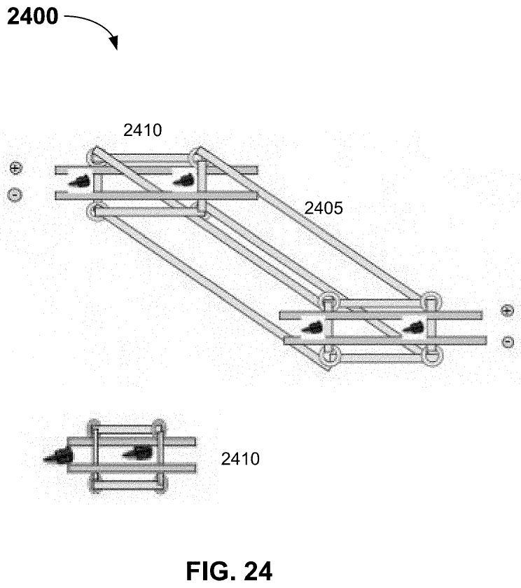

FIG. 24 is an illustration of an exemplary roller coaster 2400 with rail 2405 and electric EDF mounted armature 2410, in accordance with an embodiment of the present invention. In one embodiment of the present invention, rail 2405 may include a graphite carbon fiber, iron, copper, or aluminum linear and curved rail. Roller coaster 2400 may be mounted on a jet engine where each armature carriage is mounted with four (4) electric ducted jets. The Electric power to EDF on moving Rail Carriages with Wingets mounted is transmitted through stationary Wireless Electric Power Transmission and co located with Rails.

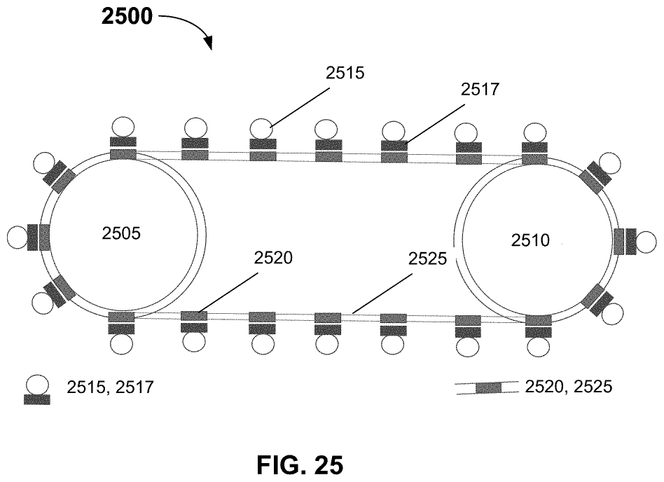

FIG. 25 is an illustration of an exemplary magnetic gear and/or belt combination gear drive mechanism 2500, in accordance with an embodiment of the present invention. In one embodiment of the present invention, magnetic belt gear drive mechanism 2500 may include a first motor 2505, a second motor 2510, winget rollers 2515 attached with magnets 2517, and magnets 2520 sandwiched between belts 2525. In another embodiment, array of tandem motors in top and bottom may drive locally passing magnets or iron mounted on passing carriages for Active Power Traction. Shown is how Magnetic Motors are coupled with Magnetic Gears mounted next to the motor, and one side the likewise magnets are attracted through mediating iron between them, as they come close and pass each other, and on the other side they get repelled, helping them to move away.

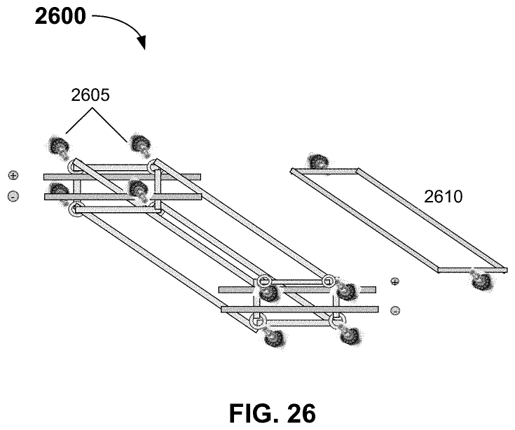

FIG. 26 is an illustration of an exemplary roller coaster 2600, in accordance with an embodiment of the present invention. In an embodiment of the present invention, BDLC motors 2605 may be mounted on roller coaster 2600. Roller coaster 2600 may include a carrier 2610 with servo mount for pitching and flipping. Or coaster 2600 may have combinations of Pitching options discussed above.

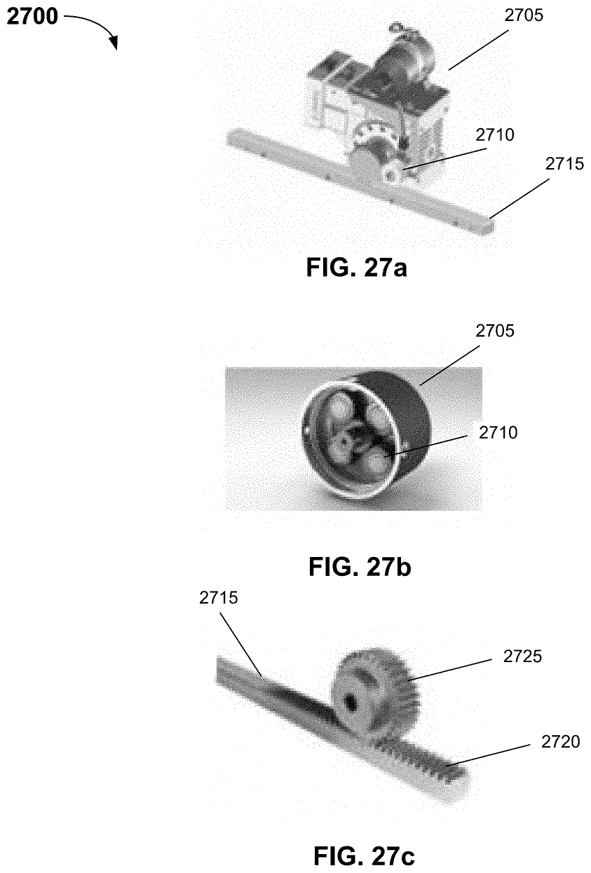

FIG. 27a-c are illustrations of exemplary rack and pinion-based traction and pitching tracks based on planetary gear, in accordance with an embodiment of the present invention. In one embodiment of the present invention, FIG. 27a shows a rack and pinion motor traction on rail, FIG. 27b shows a planetary gear-based rolling and pitching, and FIG. 27c shows a rack and pinion slider for pitch control around corners. FIG. 27a shows a Stator Motor 2705, mounted on a Rail Carriage 2715, with Round Stator Gears 2710 driving Linear Gears as Rail Guides. FIG. 27b shows Motor 2705 with Round Gears 2710. And FIG. 27c shows Linear Rail Guide 2715 Gears 2720 and Motor Round Gear 2725, a contraption such as Rack and Pinion.

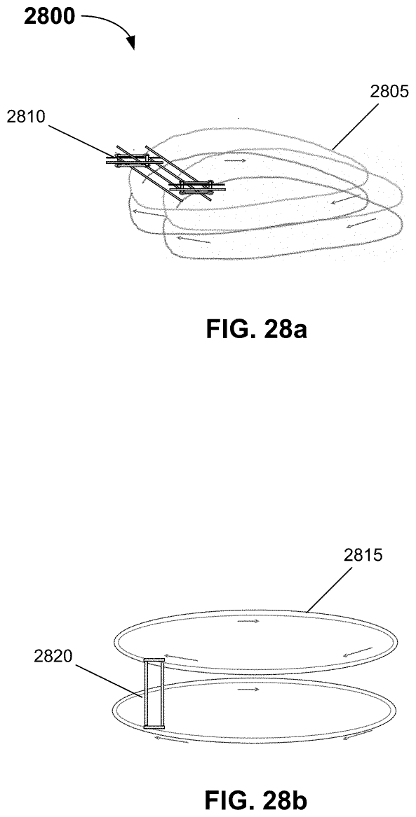

FIG. 28a-c are illustrations of an exemplary looping while keeping top-down carriage orientation up 2800, in accordance with an embodiment of the present invention. FIG. 28a illustrates a front view of active/passive tracks 2805 with carrier 2810. FIG. 28b illustrates a top view of a pitching/active passive tracks 2815 having a carrier with servo mount 2820.

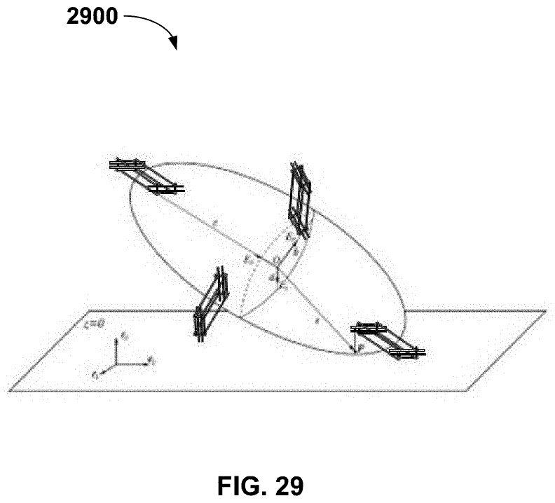

FIG. 29 is an illustration of an exemplary looping in 3D with constant lift generation 2900, in accordance with an embodiment of the present invention. The idea is like a helicopter where the rail tracks may be circular and in one plane, which is not vertical, and may be horizontal or between horizontal and vertical like a helicopter taking a roll bank. Linear Motor and Rotational Motor merge, where the Linear Rotor is local to the Tracks and the whole overall Topology may make it a Rotational Motor.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew, or any other suitable programming language. The programs may be resident on a storage medium, e.g., magnetic, or optical, e.g., without limitation, the computer hard drive, a removable disk, or media such as, without limitation, a memory stick or SD media, or other removable medium. The programs may also be run over a network, for example, with a server or other machine sending signals to the local machine, which allows the local machine to carry out the operations described herein.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent, or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3rd parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing flying machines with Vertical Take Off and Landing (VTOL) capabilities according to the present invention will be apparent to those skilled in the art. Various aspects of the invention have been described above by way of illustration, and the specific embodiments disclosed are not intended to limit the invention to the particular forms disclosed. The particular implementation of the flying machines may vary depending upon the particular context or application. By way of example, and not limitation, the flying machines described in the foregoing were principally directed to VTOL and HTOL propulsion implementations; however, similar techniques may instead be applied to flying cars, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre-AIA) or 35 USC 112(f) post-AIA. Otherwise, no limitations from the specification are to be read into any claims, unless those limitations are expressly included in the claims.

What is claimed is:

1. A system comprising:
a first propulsion unit;
a second propulsion unit;
a top winget;
a bottom winget;
two or more tracks, wherein said two or more tracks are configured to run over said first and second propulsion units; and
wherein said two or more tracks are further configured to mount said top and bottom wingets.

2. The system according to claim 1, further comprising a plurality of sliding bars.

3. The system according to claim 2, further comprising a micro frame.

4. The system according to claim 3, further comprising a meta frame.

5. The system according to claim 4, further comprising a pitching track frame that is configured to provide pitching controls.

6. The system according to claim 1, wherein said top winget comprises a first plurality of airfoils.

7. The system according to claim 2, wherein said bottom winget comprises a second plurality of airfoils.

8. The system according to claim 3, wherein said micro frame comprises a pitch traction offset controlled micro frame controlling said sliding bars.

9. The system according to claim 5, wherein said pitching controls comprises more or less four pitching configuration modes.

10. The system according to claim 9, wherein said pitching configuration modes include top and bottom winget pitched for VTOL.

11. The system according to claim 9, wherein said pitching configuration modes include pitched top winget and retreated bottom winget for for VTOL and Reverse Thrust.

12. The system according to claim 9, wherein said pitching configuration modes include retreated top winget and pitched bottom winget for VTOL and Forward Thrust.

13. The system according to claim 10, wherein said pitching configuration modes further include retreated top winget retreated and retreated bottom winget retreated.

14. The system according to claim 1, wherein said first and second propulsion units comprise at least one of a Mechanical propulsion system, a Magnetic propulsion system, and an Electric or Electrostatic propulsion system.

15. The system according to claim 1, wherein said top winget comprises a first plurality of shape shifting airfoils and said bottom winget comprises a second plurality of shape shifting airfoils.

16. The system according to claim 15, wherein one or more of said first and second plurality of shape shifting airfoils include flaps.

17. The system according to claim 16, wherein one or more of said first and second plurality of shape shifting airfoils include slats.

18. A system comprising:
means for creating thrust for VTOL and/or HTOL;
means for increasing lift at slow speed;
means for providing propulsion;
means for controlling pitch traction offset;
means for mounting said means for creating thrust for VTOL and/or HTOL to said means for providing propulsion; and
means for providing different pitching configurations.

19. A system comprising:
a first propulsion unit;
a second propulsion unit;
a top winget, wherein said top winget comprises a first plurality of airfoils;
a bottom winget, wherein said bottom winget comprises a second plurality of airfoils;
two or more tracks running over said first and second propulsion units;
said two or more tracks are configured to mount said top and bottom wingets;
a plurality of sliding bars;
a micro frame, wherein said micro frame comprises a pitch traction offset controlled micro frame controlling said sliding bars;
a pitching track frame that is configured to provide pitching controls; and
wherein said pitching controls comprises various pitching configuration modes for VTOL and/or HTOL.

20. The system according to claim 19, wherein:
said first and second propulsion units comprise at least one of a Mechanical propulsion system, a Magnetic propulsion system, and an Electric or Electrostatic propulsion system; and
said top winget comprises a first plurality of shape shifting airfoils and said bottom winget comprises a second plurality of shape shifting airfoils.
